(19) United States
(12) Patent Application Publication
(10) Pub. No.: US 2026/0147638 A1
(43) Pub. Date: May 28, 2026

(54) JOB SCHEDULING IN CLOUD SYSTEMS TO REDUCE RESOURCE FRAGMENTATION

(71) Applicant: SAP SE, Walldorf (DE)

(72) Inventor: Hui Li, Shanghai (CN)

(21) Appl. No.: 18/958,143

(22) Filed: Nov. 25, 2024

(51) Int. Cl. G06F 9/50

(52) U.S. Cl. CPC G06F 9/5083

(57) ABSTRACT

Methods, systems, and computer-readable storage media for a job scheduler system that determines a balance matrix for each group of N jobs to N job workers and a bipartite graph is generated using the balance matrix. The bipartite graph is processed using a maximum matching algorithm to ensure that the N jobs match the N job workers with a maximum value of the sum of a degree of balance of remaining resources of each of the N job workers. Each job is assigned to a respective job worker using the result of the maximum matching algorithm.

### BACKGROUND

Cloud computing can be described as Internet-based computing that provides shared computer processing resources and data to computers and other devices on demand. Users can establish respective sessions, during which processing resources and bandwidth are consumed. During a session, for example, a user is provided on-demand access to a shared pool of configurable computing resources (e.g., computer networks, servers, storage, applications, and services). The computing resources can be provisioned and released (e.g., scaled) to meet user demand.

In cloud-based environments, jobs can be periodically performed (e.g., hourly, daily, weekly, monthly) by job workers. A job can be described as a logical container that contains a single task or multiple tasks that are executed towards some end. For example, a job can be executed to perform database administration and/or database maintenance tasks (e.g., backing up, updating statistics, and/or dumping a database). Execution of a job consumes technical resources (e.g., processing, memory, network input/output (I/O)) and different jobs consume different types and/or levels of technical resources. For example, one job can be processor (central processing unit (CPU)) intensive, while another job can be memory intensive. A job scheduler system queues jobs for retrieval by job workers. However, traditional job scheduler systems fail to adequately account for disparities in consumption of technical resources between jobs, which results in inefficient use of technical resources across job workers that execute the jobs.

### SUMMARY

Implementations of the present disclosure are directed to job scheduler systems. More particularly, implementations of the present disclosure are directed to a job scheduler system that determines a balance matrix for each group of N jobs to N job workers and a bipartite graph is generated using the balance matrix. The bipartite graph is processed using a maximum matching algorithm to ensure that the N jobs match the N job workers with a maximum value of the sum of a degree of balance of remaining resources of each of the N job workers. Each job is assigned to a respective job worker using the result of the maximum matching algorithm.

In some implementations, actions include determining a set of N jobs and a set of N job workers for a time period, for each job in the set of N jobs, retrieving a set of job execution metrics, each set of job execution metrics representing historical execution of a respective job, for each job in the set of N job workers, retrieving a set of job worker metrics, each set of job worker metrics representing available resources of a respective job worker for the time period, providing a balance matrix by calculating a set of degrees of balance for each job and job worker pair for the set of N jobs and the set of N job workers, each degree of balance representing a relationship between consumption of resources of a job and available resources of a job worker of a respective job and job worker pair, generating a bipartite graph comprising a set of job nodes, a set of worker nodes, and a set of edges, each edge connecting a job node and a job worker node for a respective job and job worker pair and having an edge length assigned thereto based on the balance matrix, determining a maximum matching using the bipartite graph, the maximum matching comprising a sub-set of edges of the set of edges, and assigning each job in the set of N jobs to a job worker in the set of N job workers within a job queue using the sub-set of edges, job workers retrieving jobs from the job queue to execute the jobs. Other implementations of this aspect include corresponding systems, apparatus, and computer programs, configured to perform the actions of the methods, encoded on computer storage devices.

These and other implementations can each optionally include one or more of the following features: each degree of balance is calculated for a job and job worker pair based on a set of remaining resources of a job worker and a set of mean consumption values of a job in the job and job worker pair; a function is applied to the set of degrees of balance of the balance matrix to provide a set of edge lengths, each edge length comprising an integer; a degree of balance for a job and job worker pair is set equal to 0 in response to determining that a number of jobs concurrently executing by the job worker exceeds a maximum number of jobs; actions further include, after execution of a job by a job worker, receiving job worker metrics representing technical resources available to the job worker; actions further include, after execution of a job by a job worker, receiving a job execution history representing technical resources consumed in execution of the job by the job worker; actions further include updating a job description of the job based on the job execution history; the job queue includes, for each job, a field populated with an identifier of a job worker that the job is assigned to for execution; the maximum matching is determined by processing the bipartite graph using a maximum matching algorithm; and the maximum matching includes a maximum edge length for edges in the set of edges.

The present disclosure also provides a computer-readable storage medium coupled to one or more processors and having instructions stored thereon which, when executed by the one or more processors, cause the one or more processors to perform operations in accordance with implementations of the methods provided herein.

The present disclosure further provides a system for implementing the methods provided herein. The system includes one or more processors, and a computer-readable storage medium coupled to the one or more processors having instructions stored thereon which, when executed by the one or more processors, cause the one or more processors to perform operations in accordance with implementations of the methods provided herein.

It is appreciated that methods in accordance with the present disclosure can include any combination of the aspects and features described herein. That is, methods in accordance with the present disclosure are not limited to the combinations of aspects and features specifically described herein, but also include any combination of the aspects and features provided.

The details of one or more implementations of the present disclosure are set forth in the accompanying drawings and the description below. Other features and advantages of the present disclosure will be apparent from the description and drawings, and from the claims.

### DESCRIPTION OF DRAWINGS

FIG. 1 depicts an example architecture that can be used to execute implementations of the present disclosure.

FIG. 2 depicts an example job execution system in accordance with implementations of the present disclosure.

FIG. 3 depicts an example bipartite graph in accordance with implementations of the present disclosure.

FIG. 4 depicts an example process that can be executed in accordance with implementations of the present disclosure.

FIG. 5 is a schematic illustration of example computer systems that can be used to execute implementations of the present disclosure.

Like reference symbols in the various drawings indicate like elements.

### DETAILED DESCRIPTION

Implementations of the present disclosure are directed to job scheduler systems. More particularly, implementations of the present disclosure are directed to a job scheduler system that determines a balance matrix for each group of N jobs to N job workers and a bipartite graph is generated using the balance matrix. The bipartite graph is processed using a maximum matching algorithm to ensure that the N jobs match the N job workers with a maximum value of the sum of a degree of balance of remaining resources of each of the N job workers. Each job is assigned to a respective job worker using the result of the maximum matching algorithm.

Implementations can include actions of determining a set of N jobs and a set of N job workers for a time period, for each job in the set of N jobs, retrieving a set of job execution metrics, each set of job execution metrics representing historical execution of a respective job, for each job in the set of N job workers, retrieving a set of job worker metrics, each set of job worker metrics representing available resources of a respective job worker for the time period, providing a balance matrix by calculating a set of degrees of balance for each job and job worker pair for the set of N jobs and the set of N job workers, each degree of balance representing a relationship between consumption of resources of a job and available resources of a job worker of a respective job and job worker pair, generating a bipartite graph comprising a set of job nodes, a set of worker nodes, and a set of edges, each edge connecting a job node and a job worker node for a respective job and job worker pair and having an edge length assigned thereto based on the balance matrix, determining a maximum matching using the bipartite graph, the maximum matching comprising a sub-set of edges of the set of edges, and assigning each job in the set of N jobs to a job worker in the set of N job workers within a job queue using the sub-set of edges, job workers retrieving jobs from the job queue to execute the jobs.

To provide further context for implementations of the present disclosure, and as introduced above, in cloud-based environments, jobs can be periodically performed (e.g., hourly, daily, weekly, monthly) by job workers. A job can be described as a logical container that contains a single task or multiple tasks that are executed towards some end. For example, a job can be executed to perform database administration and/or database maintenance tasks (e.g., backing up, updating statistics, and/or dumping a database).

A job worker (e.g., a program executing on a server) retrieves a job from a job queue and executes the job. Execution of a job consumes technical resources (e.g., processing, memory, network input/output (I/O)) and different jobs consume different types and/or levels of technical resources. For example, jobs can be considered CPU-intensive (consume many CPU resources but few memory/network resources), memory-intensive (consume many memory resources but few CPU/network resources), and/or network-intensive (consume many network resources but few CPU/memory resources). A job scheduler system queues jobs in the job queue for retrieval by job workers. For example, the job scheduler system can expose the job queue through a web service application programming interface (API). Multiple job workers fetch jobs from the job queue (e.g., through the web service API) based on some load balancing algorithm (e.g., round robin), and each job worker executes a job.

However, traditional load balancing approaches fail to account for the technical resources each job will consume. As such, traditional job scheduler systems fail to adequately account for disparities in terms of technical resources consumed by different jobs, which results in inefficient use of technical resources across job workers that execute the jobs. More particularly, resource fragmentation can include disparities in the degree to which different resources are utilized for a job worker to execute jobs. For example, a job worker can have 95% memory usage and less than 50% CPU and/or network usage. In this example, because such a significant amount of memory is consumed, the job worker cannot process new jobs. Consequently, the remaining 50% of the CPU and network resources cannot be used, resulting in resource fragmentation. The resource fragmentation cannot be utilized until jobs have finished running and the memory has been fully released. This resource fragmentation results in a significant waste of technical resources and increases the technical cost of the whole platform in terms of idle technical resources.

In view of the foregoing, implementations of the present disclosure provide a job scheduler system that improves resource utilization across job workers that execute jobs to minimize resource fragmentation. As described in further detail herein, the job scheduler system of the present disclosure matches jobs to job workers based on job execution metrics and job worker metrics. More particularly, a balance matrix is determined for each group of N jobs to N workers and a bipartite graph is generated using the balance matrix. The bipartite graph is processed using a maximum matching algorithm to ensure the N jobs match the N job workers with a maximum value of the sum of a degree of balance of remaining resources of each of the N job workers.

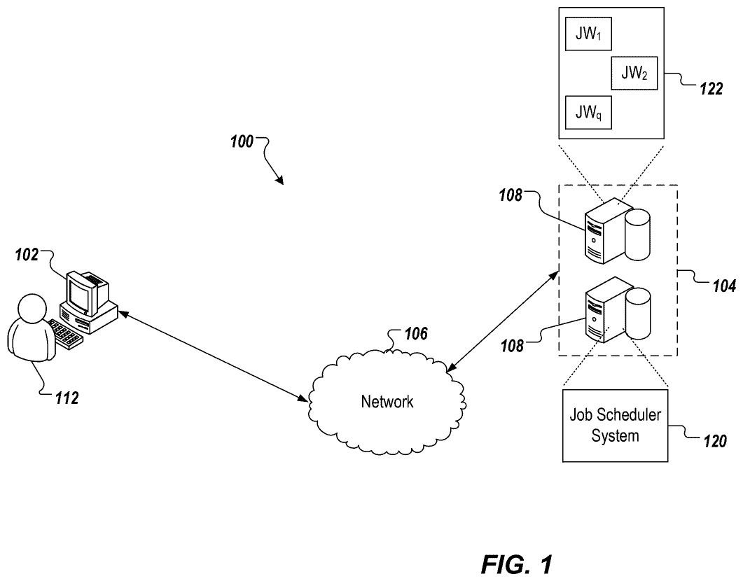

FIG. 1 depicts an example architecture 100 in accordance with implementations of the present disclosure. In the depicted example, the example architecture 100 includes a client device 102, a network 106, and a server system 104. The server system 104 includes one or more server devices and databases 108 (e.g., processors, memory). In the depicted example, a user 112 interacts with the client device 102.

In some examples, the client device 102 can communicate with the server system 104 over the network 106. In some examples, the client device 102 includes any appropriate type of computing device such as a desktop computer, a laptop computer, a handheld computer, a tablet computer, a personal digital assistant (PDA), a cellular telephone, a network appliance, a camera, a smart phone, an enhanced general packet radio service (EGPRS) mobile phone, a media player, a navigation device, an email device, a game console, or an appropriate combination of any two or more of these devices or other data processing devices. In some implementations, the network 106 can include a large computer network, such as a local area network (LAN), a wide area network (WAN), the Internet, a cellular network, a telephone network (e.g., PSTN) or an appropriate combination thereof connecting any number of communication devices, mobile computing devices, fixed computing devices and server systems.

In some implementations, the server system 104 includes at least one server and at least one data store. In the example of FIG. 1, the server system 104 is intended to represent various forms of servers including, but not limited to a web server, an application server, a proxy server, a network server, and/or a server pool. In general, server systems accept requests for application services and provides such services to any number of client devices (e.g., the client device 102 over the network 106). In accordance with implementations of the present disclosure, the server system 104 can host a job scheduler system 120 that improves resource utilization across job workers 122 as the job workers 122 execute jobs.

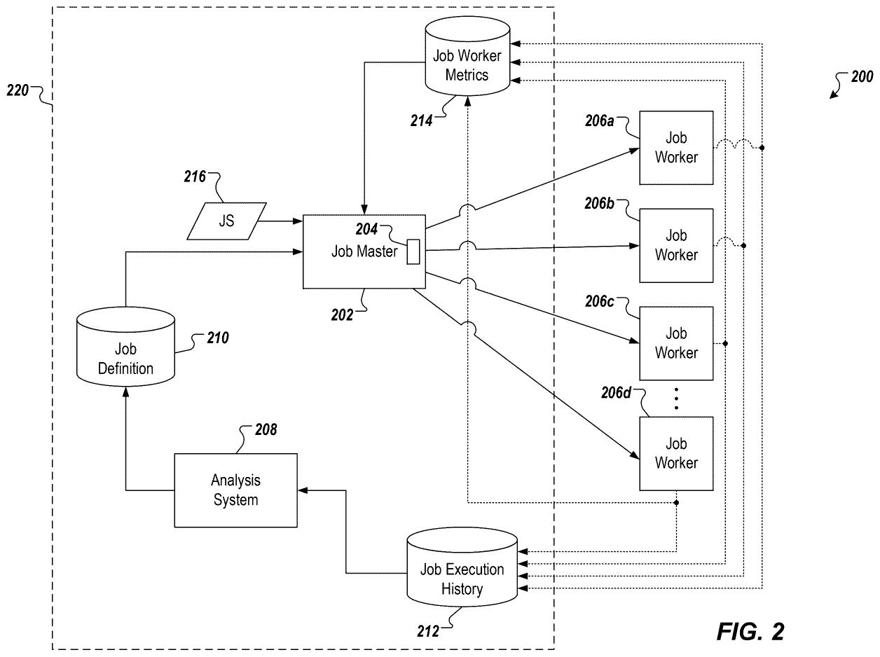

FIG. 2 depicts an example job execution system 200 in accordance with implementations of the present disclosure. In the depicted example, the job execution system 200 includes a job master 202, a job queue 204, job workers 206a, 206b, 206c, 206d, an analysis system 208, a job definition datastore 210, a job execution history datastore 212, and a job worker metrics datastore 214. In some examples, components of the job execution system 200 can be included in a job scheduler system 220 of the present disclosure. In the example of FIG. 2, the job scheduler system 220 includes the job master 202, the job queue 204, the analysis system 208, the job definition datastore 210, the job execution history datastore 212, and the job worker metrics datastore 214. In some examples, the job master 202 receives a jobs schedule 216 that informs the job master 202 of which jobs are to be executed (e.g., for a particular period of time).

In some implementations, the job definition datastore 210 stores a job definition table that records details of each job that is to be executed by the job execution system 200. Among other details, the job definition table can record, for each job, a job identifier (JOB_ID), a mean CPU usage (e.g., within a range [0, 1]), a mean memory usage (e.g., within a range [0, 1]), and a mean network usage (e.g., within a range [0, 1]). Here, the mean values of a job are determined from multiple executions of the job. If the job has been executed previously, the values of the mean CPU usage, the mean memory usage, and the mean network usage are calculated by the analysis system 208, as described in further detail herein. If the job is new and has not been previously executed, the values of the mean CPU usage, the mean memory usage, and the mean network usage are each provided as respective mean values across all jobs.

In further detail, the job master 202 reads jobs that are to be executed (e.g., for a certain period) from the jobs schedule 216 and retrieves a job definition for each job from the job definition datastore 210. The job master 202 puts the jobs into the job queue 204 and exposes a web service API. In accordance with implementations of the present disclosure, prior to putting jobs in the job queue 204, the job master 202 divides every N jobs into a group, and assigns the group of N jobs to N job workers. For example, for each job in the group of N jobs, a field is added in the queue and is populated with a job worker identifier to indicate which job worker 206a, 206b, 206c, 206d is to execute the respective job.

In some instances, it can occur that, collectively, the job workers 206a, 206b, 206c, 206d do not have sufficient resources, such that there will be some jobs in the group of N jobs that cannot be assigned to any job worker 206a, 206b, 206c, 206d. In such instances, the job master 202 puts the remaining jobs (unassigned jobs) into a next group of N jobs and tries to assign the jobs to the job workers 206a, 206b, 206c, 206d. The job workers 206a, 206b, 206c, 206d can each fetch a job from the job queue 204 and execute the job. Each job worker writes its metrics to the job worker metrics datastore 214 at regular intervals. Example job worker metrics can include, without limitation, available CPU (e.g., CPU percentage available), available memory (e.g., memory percentage available), available network bandwidth (e.g., network I/O percentage available), and a count of jobs currently executing at the job worker.

After executing a job, each job worker 206a, 206b, 206c, 206d writes the execution history of the job to the job execution history datastore 212, which can include, for each job, a set of job execution metrics, as described in further detail herein. In some examples, the analysis system 208 reads the execution history of the jobs from the job execution history datastore 212 for a period of time, calculates the mean CPU usage, the mean memory usage, and the mean network usage of each job, and, for each job, updates these values in the job definition table of the job definition datastore 210.

In accordance with implementations of the present disclosure, and as introduced above, the job master 202 assigns N jobs to N job workers 206a, 206b, 206c, 206d. In some examples, for a time period t, there is a set of jobs {job₁, . . . , jobₚ} and there is a set of job workers {worker₁, . . . , worker_{N}} that are available to execute jobs. In some examples N jobs are selected from the set of jobs in order based on time (e.g., order in which jobs are received). For example, if 10 job workers are available to execute jobs (i.e., N=10), 10 jobs are selected from the set of jobs.

In some implementations, the job master 202 assigns jobs based on the job worker metrics of the respective job workers 206a, 206b, 206c, 206d and the resource consumption of the respective jobs, as provided in the job execution metrics. For example, the following example variables can be considered:

TABLE 1
Historical Resource Consumption of Jobs and Job Worker Metrics of Job Workers

| Variable | Description |
|---|---|
| jobCPUᵢ | Historical mean CPU utilization of jobᵢ provided as the value |
| | of mean CPU usage from the job definition table. The value is |
| | in scope [0, 1]. |
| jobMemᵢ | Historical mean memory utilization of jobᵢ provided as the |
| | value of mean memory usage in the job definition table. The |
| | value is in scope [0, 1] |
| jobNetᵢ | Historical mean network bandwidth utilization of jobᵢ |
| | provided as the value of mean network usage in the job |
| | definition table. The value is in scope [0, 1] |
| workerCPUᵢ | Remaining CPU percentage of workerᵢ. The value is in scope |
| | [0, 1] |
| workerMemᵢ | Remaining memory percentage of workerᵢ. The value is in |
| | scope [0, 1] |
| workerNetᵢ | Remaining network bandwidth percentage of workerᵢ. The |
| | value is in scope [0, 1] |
| workerJobCtᵢ | The count of jobs running at workerᵢ. |

In assigning jobs to job workers, if jobᵢ were to be assigned to workerⱼ, the remaining CPU percentage, memory percentage, and network percentage of worker can respectively be provided as:

$${cpu}_{i , j} = {workerCPU}_{j} - {jobCPU}_{i}$$

$${mem}_{i , j} = {workerMem}_{j} - {jobMem}_{i}$$

$${net}_{i , j} = {workerNet}_{j} - {jobNet}_{i}$$

The average value of the remaining CPU percentage, the memory percentage, and the network percentage can be provided as:

$${avg}_{i , j} = \frac{1}{3} ( {cpu}_{i , j} + {mem}_{i , j} + {net}_{i , j} )$$

The standard deviation value of the remaining CPU percentage, the remaining memory percentage, and the remaining network percentage can be provided as:

$${std}_{i , j} = \sqrt{\frac{{( {cpu}_{i , j} - {avg}_{i , j} )}^{2} + {( {mem}_{i , j} - {avg}_{i , j} )}^{2} + {( {net}_{i , j} - {avg}_{i , j} )}^{2}}{3}}$$

In some implementations, a degree of balance of remaining resources when assigning jobᵢ to worker; can be defined as:

$${bal}_{i , j} = 1 - {std}_{i , j}$$

In general, the resources of a job worker should not be completely consumed, but rather have some resources remaining available. Further, the number of jobs assigned to a job worker should not be greater than a threshold MAX_JOBS (i.e., the maximum count of jobs that can be concurrently executed by a job worker). In view of this, the degree of balance can be revised to be provided as:

$${bal}_{i , j} = \{ \begin{matrix}0 , & if {cpu}_{i , j} < {Th}_{cpu} or {mem}_{i , j} < {Th}_{mem} or {net}_{i , j} < \\ & {Th}_{net} or {workerJobCt}_{i} \geq MAX\_JOBS \\ 1 - {std}_{i , j} , & other\end{matrix}$$

where Th_{cpu}, Thₘₑₘ, and Thₙₑₜ are a minimum CPU reserve, a minimum memory reserve, and a minimum network reserve, respectively, for each job worker. A balance matrix for N jobs and N job workers can be provided as:

$$BAL = [ \begin{matrix}{bal}_{1 , 1} & {bal}_{1 , 2} & ... & {bal}_{1 , n} \\ {bal}_{2 , 1} & {bal}_{2 , 2} & ... & {bal}_{2 , n} \\ ... & ... & ... & ... \\ {bal}_{n , 1} & {bal}_{n , 2} & ... & {bal}_{n , n}\end{matrix} ]$$

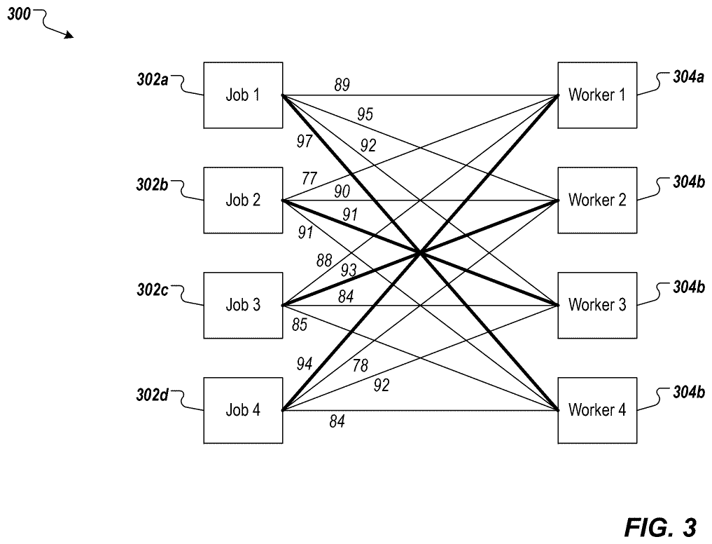

In some implementations, a bipartite graph of node pairs is constructed. FIG. 3 depicts an example bipartite graph 300 in accordance with implementations of the present disclosure. In the depicted example, the example bipartite graph 300 includes job nodes 302a, 302b, 302c, 302d and job worker nodes 304a, 304b, 304c, 304d. In the example of FIG. 3, N=4. Initially, each job node 302a, 302b, 302c, 302d is connected to each job worker node 304a, 304b, 304c, 304d by edges, each edge having a respective edge length (e_{i,j}).

In some implementations, the balance matrix BAL is converted into an edge matrix E to provide the edge lengths of the bipartite graph. The edge matrix E can be provided as:

$$E = [ \begin{matrix}{e}_{1 , 1} & {e}_{1 , 2} & ... & {e}_{1 , n} \\ {e}_{2 , 1} & {e}_{2 , 2} & ... & {e}_{2 , n} \\ ... & ... & ... & ... \\ {e}_{n , 1} & {e}_{n , 2} & ... & {e}_{n , n}\end{matrix} ]$$

$$where :$$

$${e}_{i , j} = round ( 100 \times {bal}_{i , j} )$$

The function round indicates rounding the value to an integer, such that 0≤e_{i,j}≤100.

Using the edge matrix, a set of maximum matching edges can be determined for the bipartite graph using a maximum matching algorithm. A maximum matching is a matching (i.e., a set of disjoint edges) that contains a maximum number of edges in a bipartite graph, such as that of FIG. 3. In general, the maximum matching algorithm ensures that the total length of the edges in the set of maximum matching edges of the bipartite graph is the maximum value. In this manner, it can be ensured that the N jobs are matched to the N workers with the maximum value of the sum of the degree of balance of remaining resources. In some examples, if an edge length is 0 (which means the corresponding job worker does not have enough resources to execute the corresponding job, or the job count of the corresponding job worker has reached MAX_JOBS), the corresponding job is not assigned to the job worker. Instead, the job is added to the next group of N jobs.

In further detail, an example maximum matching algorithm includes, without limitation, the Hungarian algorithm, which can be described as, given a bipartite graph, determine a matching of maximum size by starting with any matching sets of edges R and constructing a tree using a breadth-first search to find an augmenting path P. The path P starts and finishes at unmatched nodes whose first and last edges are not in R and whose edges alternate being outside and inside of R. A successful search results in the symmetric difference of R and the edges in P yielding a matching having one more edge than R. Another search is executed to attempt to define a new augmenting path. If the search is unsuccessful, the algorithm terminates. As output of the maximum matching algorithm, R is the largest-size matching that exists. While implementations of the present disclosure are described herein with reference to the Hungarian algorithm, any appropriate maximum matching algorithm can be used, such as the Hopcroft-Karp algorithm.

For purposes of illustration, a non-limiting example can be discussed, in which N is 4, and the balance matrix is provided as:

$$BAL = [ \begin{matrix}0.92 & 0.77 & 0.88 & 0.94 \\ 0.95 & 0.9 & 0.93 & 0.78 \\ 0.92 & 0.91 & 0.84 & 0.92 \\ 0.97 & 0.93 & 0.85 & 0.84\end{matrix} ]$$

The following example edge matrix of the bipartite graph is provided as:

$$E = [ \begin{matrix}89 & 77 & 88 & 94 \\ 95 & 90 & 93 & 78 \\ 92 & 91 & 84 & 92 \\ 97 & 91 & 85 & 84\end{matrix} ]$$

Using the maximum matching algorithm, the maximum matching of this example is the collection of pairs: (job₁, worker₄), (job₂, worker₃), (job₃, worker₂), (job₄, worker₁). Here, the total length of selected edges is 94+93+91+97=375 and the sum of the degree of balance is 0.94+0.93+0.91+0.97=3.75. In FIG. 3, the bolded edges represent the example assignment of jobs to job workers in accordance with this example. In assigning the jobs to job workers, for each job, a field is included in the job queue, which indicates the job worker (e.g., by job worker identifier) that the job is assigned to.

Referring again to FIG. 2, the job workers 206a, 206b, 206c, 206d each fetch a job per the respective assignments from the job queue 204 (e.g., through the web service API exposed by the job master 202). For each successfully executed job, the job worker 206a, 206b, 206c, 206d that executed the job determines a set of job execution metrics, which includes the total execution time (TOTAL_EXEC_TIME), CPU time cost (CPU_TIME), memory cost (MEMORY), network input (NETWORK_IN), and network output (NETWORK_OUT) of the job. Programming languages that can be used for job workers, such as Java, provide interfaces to determine each thread's resource cost, such as CPU time, memory, network input, and network output. As a result, this information is available for the job worker to calculate the metrics of each job. The set of metrics for each job is stored into a database table (JOB_EXEC_HISTORY). In some examples, the database table is stored in the job execution history datastore 212. An example data structure of the database table is provided in Table 2:

TABLE 2
Example Data Structure of Database Table (JOB_EXEC_HISTORY)

| Column | Type | Remark | Example Value |
|---|---|---|---|
| JOB_ID | Number | The identifier of the job. | |
| TIME_STAMP | Timestamp | The timestamp of job | 2025-07- |
| | | execution start. | 09T12:44:26 |
| TOTAL_EXEC_TIME | Number | The total execution time of | 1800000 ms |
| | | the job. | |
| CPU_TIME | Number | The CPU time cost of the | 900000 ms |
| | | job . | |
| MEMORY | Number | The memory cost of the job. | 50M |
| NETWORK_IN | Number | The network input cost of | 10M |
| | | the job. | |
| NETWORK_OUT | Number | The network output cost of | 80M |
| | | the job. | |

In accordance with implementations of the present disclosure, the analysis system 208 reads the latest job execution history records from database table to periodically determine the mean CPU usage, the mean memory usage, and the mean network usage for each job. The following example relationships can be provided:

$$MEAN\_CPU \_USAGE = \frac{{\sum }_{k = 1}^{M} COST\_CPU {\_TIME}_{k}}{{\sum }_{k = 1}^{M} {COST\_TIME}_{k}}$$

$$MEAN\_MEM \_USAGE = \frac{{\sum }_{k = 1}^{M} {COST\_MEMORY}_{k}}{M \times WORKER\_MEMORY}$$

$$MEAN\_NET \_USAGE = \frac{{\sum }_{k = 1}^{M} {COST\_NETWORK}_{k}}{{\sum }_{k = 1}^{M} {COST\_TIME}_{k} \times WORKER\_NETWORK}$$

Table 3 provides a summary of the variables included in the above relationships:

TABLE 3
Summary of Variables.

| Variable | Explanation |
|---|---|
| M | The count of execution history records of a job in a time |
| | window. |
| COST_CPU_TIMERₖ | The CPU time cost of the k^{th} execution history record of the |
| | job. |
| COST_TIMERₖ | The time cost of the k^{th} execution history record of the job. |
| MEAN_CPU_USAGE | the mean CPU utilization of the job. |
| COST_MEMORYₖ | The memory cost of the k^{th} execution history record of the job. |
| WORKER_MEMORY | The total memory size of one job worker. |
| MEAN_MEM_USAGE | The mean memory utilization of the job. |
| COST_NETWORKₖ | The network IO cost of the k^{th} execution history record of the |
| | job. |
| WORKER_NETWORK | The network bandwidth of one job worker. |
| MEAN_NET_USAGE | the mean network bandwidth utilization of the job. |

The analysis system 208 updates the mean CPU usage, the mean memory usage, and the mean network usage for each job in the job definition table stored in the job definition datastore 210.

It can be noted that, as jobs are executed, the number of jobs in the set of jobs {job₁, . . . , jobₚ} diminishes to a point where there are less than N jobs in the set of jobs. That is, there are more job workers available than there are jobs to be executed. In such instances, mock jobs can be added to bring the number of jobs to N jobs. For example, if there are n jobs remaining to be executed, where n<N, m mock jobs can be added to provide N jobs (e.g., m=N−n). In some examples, coefficients of the mock jobs can be set equal to 0. The N jobs are allocated to the N job workers, as described herein, and, after allocation, the mock jobs are discarded (e.g., the mock jobs are not added to the job queue 204).

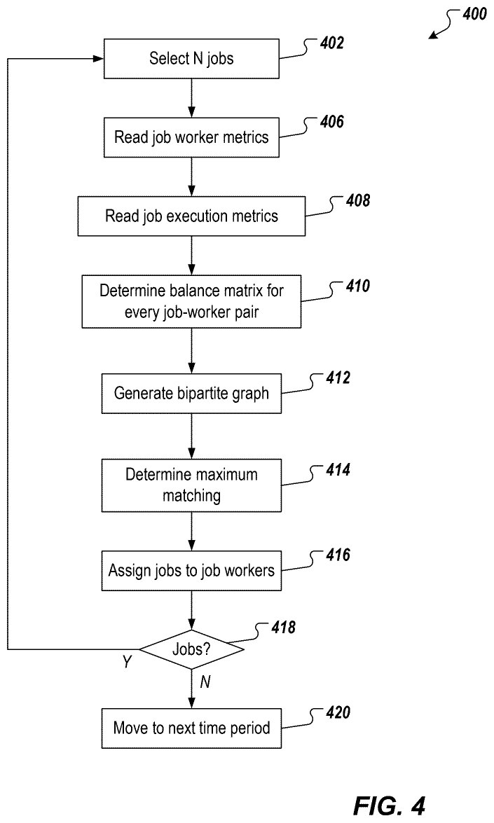

FIG. 4 depicts an example process 400 that can be executed in accordance with implementations of the present disclosure. In some examples, the example process 400 is provided using one or more computer-executable programs executed by one or more computing devices. In some examples, the example process 400 is executed for a time period t, over which a set of jobs (e.g., {job₁, . . . , jobₚ}) are to be executed by a set of job workers (e.g., {worker₁, . . . , worker_{N}}).

A group of N jobs is selected from the set of jobs (402). For example, and as described herein, N jobs are selected from the set of jobs (e.g., in time order). Job worker metrics are read (406). For example, and as described herein, the job master 202 can read job worker metrics for each of the N job workers from the job worker metrics datastore 214. Job execution metrics are read (408). For example, and as described herein, the job master 202 can read job execution metrics for each of the N jobs from the job definition table stored in the job definition datastore 210.

A balance matrix is determined for all job-worker pairs (410). For example, and as described herein, for each pair of jobᵢ and worker, a degree of balance bal_{i,j} is determined and populates the balance matrix BAL. A bipartite graph is generated (412). For example, and as described herein, a bipartite graph of node pairs is generated with a set of job nodes and a set of worker nodes. Each job node is connected to each worker node by an edge. Edge lengths are determined for each edge using the balance matrix. For example, an edge matrix E is generated from the balance matrix, as described herein, and edge lengths are assigned to respective edges using the edge matrix.

A maximum matching is determined (414). For example, and as described herein, the bipartite graph is processed through a maximum matching algorithm, which outputs a maximum matching as a set of disjoint edges between job nodes and job worker nodes in the bipartite graph. Each edge represents an assignment between a job and a job worker. Jobs are assigned to job workers (416). For example, and as described herein, using the maximum matching, the jobs are assigned to the job workers, where, for each job added to the job queue 204, a field is included that indicates the job worker assigned to the job. It is determined whether any jobs remain to be assigned (418). For example, if all jobs in the set of jobs (e.g., {job₁, . . . , jobₚ}ₜ) have been assigned to job workers, there are no jobs remaining to be assigned for the time period t. If there are no jobs remaining to be assigned, the example process 400 moves to a next time period (420) to assign a new set of jobs. If there are jobs remaining to be assigned, the example process 400 loops back. In some examples, if the example process 400 is executed multiple times for the set of jobs for the time period t, it can occur that there can be less than N jobs remining. For example, there can be n jobs remaining, where n<N. In such cases, a last iteration of the example process 400 can add m mock jobs to provide N jobs that are assigned to N job workers and, after assignment, the mock jobs are discarded.

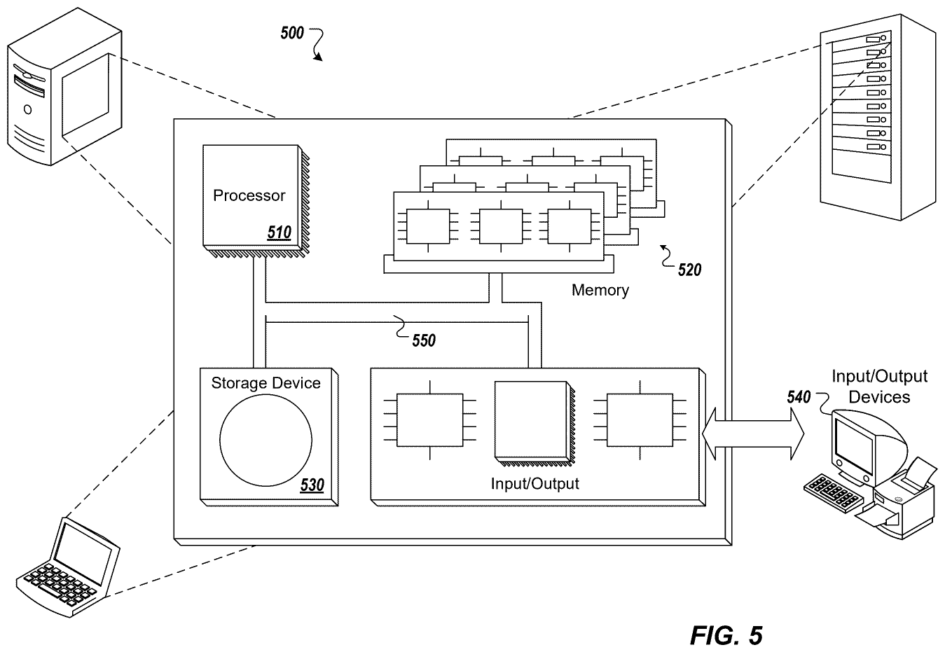

Referring now to FIG. 5, a schematic diagram of an example computing system 500 is provided. The system 500 can be used for the operations described in association with the implementations described herein. For example, the system 500 may be included in any or all of the server components discussed herein. The system 500 includes a processor 510, a memory 520, a storage device 530, and an input/output device 540. The components 510, 520, 530, 540 are interconnected using a system bus 550. The processor 510 is capable of processing instructions for execution within the system 500. In some implementations, the processor 510 is a single-threaded processor. In some implementations, the processor 510 is a multi-threaded processor. The processor 510 is capable of processing instructions stored in the memory 520 or on the storage device 530 to display graphical information for a user interface on the input/output device 540.

The memory 520 stores information within the system 500. In some implementations, the memory 520 is a computer-readable medium. In some implementations, the memory 520 is a volatile memory unit. In some implementations, the memory 520 is a non-volatile memory unit. The storage device 530 is capable of providing mass storage for the system 500. In some implementations, the storage device 530 is a computer-readable medium. In some implementations, the storage device 530 may be a floppy disk device, a hard disk device, an optical disk device, or a tape device. The input/output device 540 provides input/output operations for the system 500. In some implementations, the input/output device 540 includes a keyboard and/or pointing device. In some implementations, the input/output device 540 includes a display unit for displaying graphical user interfaces.

The features described can be implemented in digital electronic circuitry, or in computer hardware, firmware, software, or in combinations of them. The apparatus can be implemented in a computer program product tangibly embodied in an information carrier (e.g., in a machine-readable storage device, for execution by a programmable processor), and method steps can be performed by a programmable processor executing a program of instructions to perform functions of the described implementations by operating on input data and generating output. The described features can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors of any kind of computer. Generally, a processor will receive instructions and data from a read-only memory or a random access memory or both. Elements of a computer can include a processor for executing instructions and one or more memories for storing instructions and data. Generally, a computer can also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the features can be implemented on a computer having a display device such as a CRT (cathode ray tube) or LCD (liquid crystal display) monitor for displaying information to the user and a keyboard and a pointing device such as a mouse or a trackball by which the user can provide input to the computer.

The features can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include, for example, a LAN, a WAN, and the computers and networks forming the Internet.

The computer system can include clients and servers. A client and server are generally remote from each other and typically interact through a network, such as the described one. The relationship of client and server arises by virtue of computer programs running on the respective computers and having a client-server relationship to each other.

In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other implementations are within the scope of the following claims.

A number of implementations of the present disclosure have been described. Nevertheless, it will be understood that various modifications may be made without departing from the spirit and scope of the present disclosure. Accordingly, other implementations are within the scope of the following claims.

What is claimed is:

1. A computer-implemented method for distributing jobs for execution by job workers in cloud-based environments, the method being executed by one or more processors and comprising:
determining a set of N jobs and a set of N job workers for a time period;
for each job in the set of N jobs, retrieving a set of job execution metrics, each set of job execution metrics representing historical execution of a respective job;
for each job in the set of N job workers, retrieving a set of job worker metrics, each set of job worker metrics representing available resources of a respective job worker for the time period;
providing a balance matrix by calculating a set of degrees of balance for each job and job worker pair for the set of N jobs and the set of N job workers, each degree of balance representing a relationship between consumption of resources of a job and available resources of a job worker of a respective job and job worker pair;
generating a bipartite graph comprising a set of job nodes, a set of worker nodes, and a set of edges, each edge connecting a job node and a job worker node for a respective job and job worker pair and having an edge length assigned thereto based on the balance matrix;
determining a maximum matching using the bipartite graph, the maximum matching comprising a sub-set of edges of the set of edges; and
assigning each job in the set of N jobs to a job worker in the set of N job workers within a job queue using the sub-set of edges, job workers retrieving jobs from the job queue to execute the jobs.

2. The method of claim 1, wherein each degree of balance is calculated for a job and job worker pair based on a set of remaining resources of a job worker and a set of mean consumption values of a job in the job and job worker pair.

3. The method of claim 1, wherein a function is applied to the set of degrees of balance of the balance matrix to provide a set of edge lengths, each edge length comprising an integer.

4. The method of claim 1, wherein a degree of balance for a job and job worker pair is set equal to 0 in response to determining that a number of jobs concurrently executing by the job worker exceeds a maximum number of jobs.

5. The method of claim 1, further comprising, after execution of a job by a job worker, receiving job worker metrics representing technical resources available to the job worker.

6. The method of claim 1, further comprising, after execution of a job by a job worker, receiving a job execution history representing technical resources consumed in execution of the job by the job worker.

7. The method of claim 6, further comprising updating a job description of the job based on the job execution history.

8. The method of claim 1, wherein the job queue comprises, for each job, a field populated with an identifier of a job worker that the job is assigned to for execution.

9. The method of claim 1, wherein the maximum matching is determined by processing the bipartite graph using a maximum matching algorithm.

10. The method of claim 1, wherein the maximum matching comprises a maximum edge length for edges in the set of edges.

11. A non-transitory computer-readable storage medium coupled to one or more processors and having instructions stored thereon which, when executed by the one or more processors, cause the one or more processors to perform operations for distributing jobs for execution by job workers in cloud-based environments, the operations comprising:
determining a set of N jobs and a set of N job workers for a time period;
for each job in the set of N jobs, retrieving a set of job execution metrics, each set of job execution metrics representing historical execution of a respective job;
for each job in the set of N job workers, retrieving a set of job worker metrics, each set of job worker metrics representing available resources of a respective job worker for the time period;
providing a balance matrix by calculating a set of degrees of balance for each job and job worker pair for the set of N jobs and the set of N job workers, each degree of balance representing a relationship between consumption of resources of a job and available resources of a job worker of a respective job and job worker pair;
generating a bipartite graph comprising a set of job nodes, a set of worker nodes, and a set of edges, each edge connecting a job node and a job worker node for a respective job and job worker pair and having an edge length assigned thereto based on the balance matrix;
determining a maximum matching using the bipartite graph, the maximum matching comprising a sub-set of edges of the set of edges; and
assigning each job in the set of N jobs to a job worker in the set of N job workers within a job queue using the sub-set of edges, job workers retrieving jobs from the job queue to execute the jobs.

12. The non-transitory computer-readable storage medium of claim 11, wherein each degree of balance is calculated for a job and job worker pair based on a set of remaining resources of a job worker and a set of mean consumption values of a job in the job and job worker pair.

13. The non-transitory computer-readable storage medium of claim 11, wherein a function is applied to the set of degrees of balance of the balance matrix to provide a set of edge lengths, each edge length comprising an integer.

14. The non-transitory computer-readable storage medium of claim 11, wherein a degree of balance for a job and job worker pair is set equal to 0 in response to determining that a number of jobs concurrently executing by the job worker exceeds a maximum number of jobs.

15. The non-transitory computer-readable storage medium of claim 11, wherein operations further include, after execution of a job by a job worker, receiving job worker metrics representing technical resources available to the job worker.

16. A system, comprising:
a computing device; and
a computer-readable storage device coupled to the computing device and having instructions stored thereon which, when executed by the computing device, cause the computing device to perform operations for distributing jobs for execution by job workers in cloud-based environments, the operations comprising:
determining a set of N jobs and a set of N job workers for a time period;
for each job in the set of N jobs, retrieving a set of job execution metrics, each set of job execution metrics representing historical execution of a respective job;
for each job in the set of N job workers, retrieving a set of job worker metrics, each set of job worker metrics representing available resources of a respective job worker for the time period;
providing a balance matrix by calculating a set of degrees of balance for each job and job worker pair for the set of N jobs and the set of N job workers, each degree of balance representing a relationship between consumption of resources of a job and available resources of a job worker of a respective job and job worker pair;
generating a bipartite graph comprising a set of job nodes, a set of worker nodes, and a set of edges, each edge connecting a job node and a job worker node for a respective job and job worker pair and having an edge length assigned thereto based on the balance matrix;
determining a maximum matching using the bipartite graph, the maximum matching comprising a sub-set of edges of the set of edges; and
assigning each job in the set of N jobs to a job worker in the set of N job workers within a job queue using the sub-set of edges, job workers retrieving jobs from the job queue to execute the jobs.

17. The system of claim 16, wherein each degree of balance is calculated for a job and job worker pair based on a set of remaining resources of a job worker and a set of mean consumption values of a job in the job and job worker pair.

18. The system of claim 16, wherein a function is applied to the set of degrees of balance of the balance matrix to provide a set of edge lengths, each edge length comprising an integer.

19. The system of claim 16, wherein a degree of balance for a job and job worker pair is set equal to 0 in response to determining that a number of jobs concurrently executing by the job worker exceeds a maximum number of jobs.

20. The system of claim 16, wherein operations further include, after execution of a job by a job worker, receiving job worker metrics representing technical resources available to the job worker.
